(19) United States
(12) Patent Application Publication
(10) Pub. No.: US 2006/0140112 A1
(43) Pub. Date: Jun. 29, 2006

(54) Method and apparatus to provide quality of service to wireless local area networks

(75) Inventor: Boris Ginzburg, Haifa (IL)

Correspondence Address: PEARL COHEN ZEDEK LATZER, LLP, 1500 BROADWAY, 12TH FLOOR, NEW YORK, NY, 10036, US

(73) Assignee: INTEL CORPORATION

(21) Appl. No.: 11/022,873

(22) Filed: Dec. 28, 2004

(51) Int. Cl. H04L 1/00; H04L 12/26; H04L 12/28; H04Q 7/00; H04Q 7/24; H04L 12/56

(52) U.S. Cl. 370/229; 370/389; 370/328; 370/338

(57) ABSTRACT

Briefly, a method and apparatus to classify a data unit according to a type of service of the data unit. The apparatus includes a transmitter controller to control transmission of the classified data unit according to a transmission mechanism suitable for a class of the data unit.

### BACKGROUND OF THE INVENTION

An IEEE-802.11-1999 family of standards which relates to a wireless medium access control (MAC) and physical layer (PHY) may be used in wireless local area networks (WLAN). A member of this family is the IEEE-802.11e standard which relates to MAC enhancements for quality of service (QoS). The IEEE 802.11e standard provides two mechanisms and/or methods for supporting applications with QoS requirements.

The first mechanism, an enhanced distributed channel access (EDCA), may deliver data traffic based on differentiating a user priority (UP). The UP may be assigned to a MAC Service Data Unit (MSDU) in communication layers above the MAC layer and may indicate how to handle the MSDU. This differentiation may be achieved by various operations such as, for example, varying the amount of idle time of a channel that a station may sense before backoff and/or transmission of MSDU, setting a length of a contention window (CW) used for the backoff, or setting the transmission duration of the station after acquiring channel access. According to the proposed IEEE 802.11e standard, the EDCA mechanism may use eight different UPs and four access categories (ACs) that provide support for the delivery of the MSDU.

The second mechanism, a hybrid coordination function controlled channel access (HCCA), may be based on reservation of transmission opportunities (TXOPs) by an access point (AP) per traffic stream. A station (STA) may request TXOPs both for its own transmissions and for transmissions to the station from a QoS access point (QAP). The AP either accepts or rejects the request based on an admission control policy. If the request is accepted, the AP may schedule TXOPs for both the AP and the STA. The AP may poll data frames from the STA and may directly deliver queued frames to the STA. The HCCA mechanism may be used for applications such as voice and video, which may need periodic service from a hybrid coordinator (HC).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention;

FIG. 2 is a schematic block diagram of a portion of a medium access control (MAC) processor that may process data packets for transmission according to some exemplary embodiments of the present invention; and

FIG. 3 is a schematic flowchart of a method of processing a data unit for transmission according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, or transmission devices.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

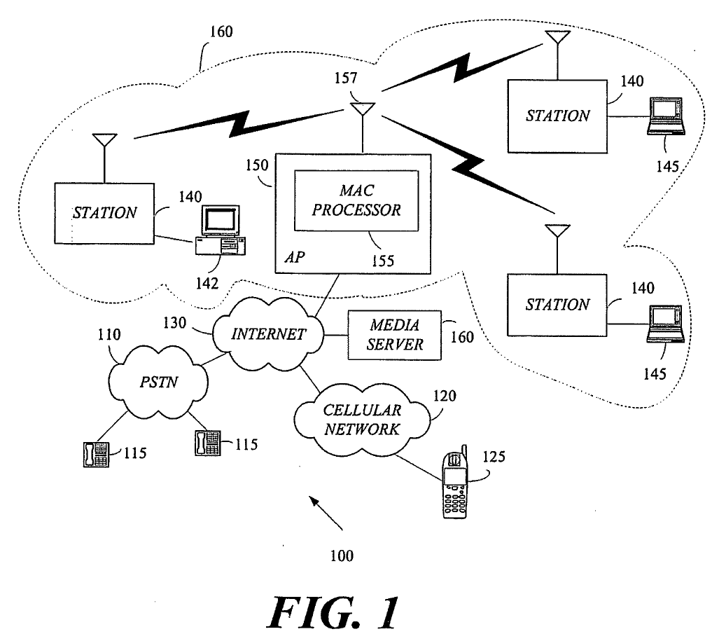

Turning first to FIG. 1, a communication system 100 according to embodiments of the present invention, is shown. Although the scope of the present invention is not limited in this respect, communication system 100 may include a plurality of communication networks such as, for example, a cellular network 110, a public switched telephone network (PSTN) 120 and a connection to the Internet 130 via a wireless communication network (WLAN) 160.

According to this exemplary embodiment of the invention, PSTN 110 may include telephones 115 and may provide voice, data and facsimile calls to Internet 130, if desired. Cellular network 120 may includes one or more cellular devices 125 which may provide voice, data, video and facsimile calls to Internet 130, if desired. Media server 160 may convert the voice, data, video and facsimile signals into data packets for performing voice and/or video calls over Internet Protocol (IP), if desired.

Although the scope of the present invention is not limited in this respect, according to this exemplary embodiment of the invention, WLAN 160 may include an access point 150 and one or more stations 140. Stations 140 may be coupled to desktop computers 142 and/or laptop computers 145, printers (not shown) or the like. According to some embodiments of the invention, AP 150 may include a MAC processor 155, which may include a first processor to process data packets for transmission and a second processor to process received data packets.

Although the scope of the present invention is not limited in this respect, MAC processor 155 may receive from Internet 130 via an antenna 157 real time data packets that may include, for example, voice, video, or the like, and may transfer the real time data packets to stations 140, if desired. According to some embodiments of the invention, MAC processor 155 may include a classifier to classify a data unit according to a type of service of the data unit and to output a classified data unit. In addition, MAC processor 155 may include a transmitter controller to control transmission of the classified data unit according to a transmission mechanism suitable for a class of the data unit, if desired. Media server 160 may process the real time data packets and may deliver those data packets to telephones 115 and/or cellular 125 through Internet 130, if desired.

Although the scope of the present invention is not limited in this respect, an antenna 157 may include two or more antennas of one of the following types: an omni-directional antenna, a monopole antenna, a dipole antenna, an end fed antenna, a circularly polarized antenna, a micro-strip antenna, a diversity antenna, an antenna array, an internal antenna or the like.

Although the scope of the present invention is not limited in this respect, AP 150 may employ one or more quality of service (QoS) mechanisms, schemes, algorithms and/or methods to control data streams transactions across the network. For example, AP 150 may include a Service Access Point (SAP) and may use a QoS mechanism and/or algorithm that may be based on reservation of transmission opportunities (TXOPs) per transmission of a data stream. According to some exemplary embodiments, stations 140 may request reservation of TXOPs for its own transmissions and for AP 150 transmissions. AP 150 may accept or reject the request based on an agreed WLAN control policy, for example, admission control policy of IEEE-802.11e standard, if desired.

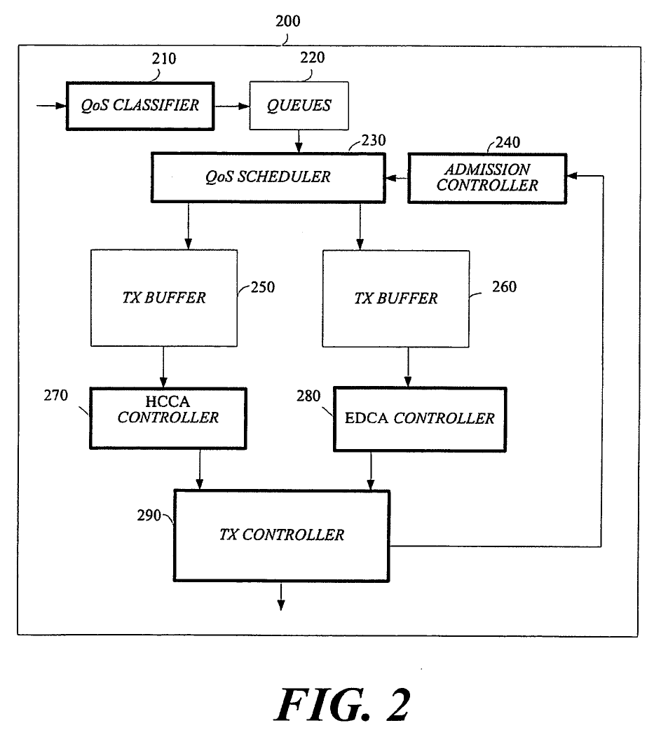

Turning to FIG. 2, a schematic block diagram of a portion of a medium access control (MAC) processor 200 that may process data packets for transmission according to some exemplary embodiments of the present invention is shown. Although the scope of the present invention is not limited in this respect, this exemplary portion of MAC processor 200 may include a QoS classifier 210, queues 220, a QoS scheduler 230, an admission control unit 240, a transmission buffer 250, an HCCA controller 260, an EDCA controller 270 and a transmission (TX) controller 280.

According to some exemplary embodiment of the invention, QoS classifier 210 may receive one or more data units for example, a MSDU, from an upper communication layer, for example, a service access point (SAP) layer, and may classify the data unit according to an identifier, for example a traffic identifier (TID), if desired. According to some embodiments of the invention, data units may be transmitted according to a desired QoS mechanism. For example, in wireless networks base on IEEE-802.11 1999 standards, data units may be transmitted according to an EDCA mechanism and/or according to an HCCA mechanism, although the scope of the present invention is not limited in this respect.

According to this exemplary embodiment of the invention, the data units may be classified based on their content into one or more transmission classes by QoS classifier 210, if desired. For example, the EDCA mechanism may be used to transmit data units that may include TID which relates to one transmission class and the HCCA mechanism may be used to transmit data units which may be related to another transmission class and may include a traffic stream identifier (TSID), although the scope of the present invention is not limited in this respect.

According to embodiments of the invention, a classified data unit may be queued before further processing in queues 220. According to some exemplary embodiments of the invention, queues 220 may include a plurality of queues, for example, eight queues that may queue data units of the EDCA mechanism and eight queues that may queue data units of the HCCA mechanism. QoS scheduler 230 may be able to select a data unit and/or a data packet from a head of at least one queue of queues 220 and may input the selected data unit into Tx buffer 250 and/or into Tx buffer 260 according to desired transmission mechanism.

Although the scope of the present invention is not limited in this respect, Tx buffers 250 and 260 may operate as First In First Out (FIFO) buffers. For example, Tx buffer 260 may include four FIFO buffers and Tx buffer 250 may include N HCCA FIFO buffers, wherein N may be within the range of 1<=N<=8. In some exemplary embodiments of the present invention Tx buffer 250 may include two HCCA FIFO buffers, wherein one buffer may be used to process frames under 500 Bytes and the other buffer may be used to process frames over 500 Bytes, although the scope of the present invention is in no way limited in this respect.

According to some exemplary embodiments of the invention, HCCA controller 270 may receive data units from Tx buffer 250 and may be capable of controlling transmissions of the data units according to the HCC mechanism. For example, HCCA controller 270 may start transmission of the data unit according to a frame (e.g. QOS-POLL frame) which may signal to an AP to start transmission of frames for a predetermined period of time. For example, a QoS-POLL frame may control a start and/or an end of TXOP, may send QoS—NULL data with queue size or TXOP request, and perform other operations, if desired

Although the scope of the present invention is not limited in this respect, EDCA controller 280 may receive data units from Tx buffer 260 and may be capable of controlling transmissions of the data units according to the EDCA mechanism. For example, EDCA controller 280 may prioritize access per AC, may count used time per packet for admission control and may count collisions, for example, using a virtual collision counter, may control the start/end of TXOP, may activate a burst protector, and may perform other operations, if desired.

According to some embodiments of the present invention Tx controller 290 may receive commands from HCCA controller 270 and EDCA controller 280 and may initialize physical layer (PHY) for transmission, may activate security mechanisms, may monitor the channel status, and the like.

Although the scope of the present is not limited in this respect, admission controller 240 may control access to a channel. For example, according to some exemplary embodiments of the invention, admission controller 240 may compute an air-time for an admission frame related to an Access Categories (AC), may accumulate the air-time then in a register and may compare the accumulated time with “credit” obtained from an AP. If the “used” time is longer than “credit”, the admission frames may be sent using a lower AC which is not marked as mandatory frames, although the scope of the present invention is in no way limited in this respect.

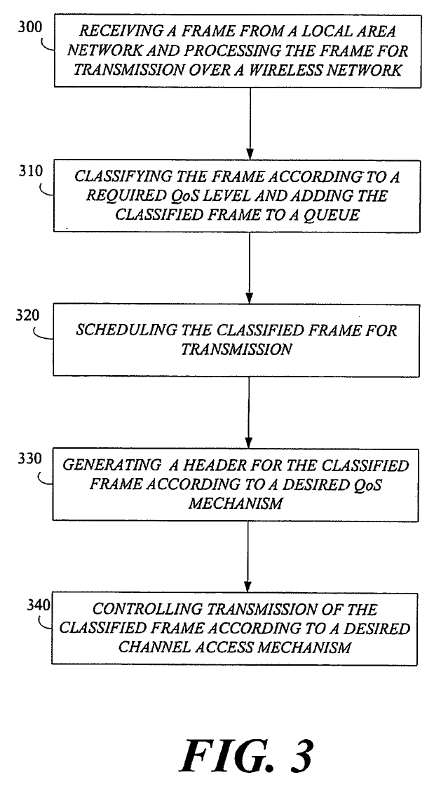

Turning to FIG. 3, a flowchart of a method of processing a data unit for transmission according to exemplary embodiments of the invention is shown. Although the scope of the present invention is not limited in this respect, the data unit may be processed in one or more communication layers. For example, in a MAC management layer of a service AP, a data unit which may include one or more frames may be received from a local area network (LAN) (e.g. Internet 130 of FIG. 1) and may be processed to be transmitted over WLAN 160, if desired (text block 300).

According to an exemplary embodiment of the invention, a header of the received frame may be replaced with a header template according to a desired wireless network standard. For example, the wireless network standard may be IEEE 802.11-1999 and the header template may include an Address 1, 2, 3 fields and a TID field.

According to this exemplary method, in an upper MAC layer the frame may be classified according to a required QoS level and the classified frame may be added to a queue, e.g. one of queues 220 (text block 310). For example, QoS classifier 210 may assign a TID according to IEEE 802.1d standard to the frame of the data unit, may add the data unit to a suitable queue of queues 220, may assign a sequential number per TID, may select an initial rate, Tx power, and channel access protection mode, and may build a MAC header, although the scope of the present invention is in no way limited in this respect.

According to the exemplary method of FIG. 3, QoS scheduler 230 may schedule the classified frame for transmission (text block 320) and may generate a header based on the header template for the classified frame according to a desired mechanism (text block 330). For example, QoS scheduler 230 may merge packets from queues 220 into Tx buffer 250 and/or Tx buffer 260 according to the desired QoS mechanism for transmission. In addition, QoS scheduler 230 may manage Tx buffers 250, 260, may delay data units for transmissions, and may mange counters of admission controller 240, although the scope of the present invention is in no way limited in this respect.

According to some exemplary embodiments of the invention, in the lower MAC layer, Tx controller 290 may control the transmission of the classified frame according to a QoS mechanism and according to a desired channel access mechanism. For example, HCCA controller 270 and/or EDCA controller 280 may control the transmission according to a selected QoS mechanism.

According to some exemplary embodiments, Tx controller 290 may set an acknowledge (ACK) policy according to the IEEE 802.11/802.11e standard in a MAC header of the frame, may build a request to send and/or a clear to send (RTS/CTS) to the transmitted frames, may start transmission according to a back-off timer, may receive ACK and CTS frames and may control time-out counters, if desired. In addition, Tx controller 290 may control retransmission of data units, may build a transmission vector, may control encryption, may control start/end of TXOP and may respond to HCCA polling, although the scope of the present invention is in no way limited in this respect.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. An apparatus comprising:
a classifier to classify a data unit according to a type of service of the data unit and to output a classified data unit; and
a transmitter controller to control transmission of the classified data unit according to a transmission mechanism suitable for a class of the data unit.

2. The apparatus of claim 1 wherein the classifier is capable of classifying the data unit according to one or more parameters of a traffic stream.

3. The apparatus of claim 2 comprising:
two or more queues to store the data unit based on the type of service and a desired parameter of the traffic stream, respectively.

4. The apparatus of claim 3 comprising:
a quality of service scheduler to schedule the classified data unit for transmission from a desired queue of the two or more queues.

5. The apparatus of claim 4, comprising:
two or more quality of service controllers to control the transmission of the classified data unit according to a desired quality of service mechanism.

6. The apparatus of claim 1 wherein the transmission mechanism includes a quality of service mechanism.

7. A method comprising:
classifying and queuing a data unit for transmission according to a type of service of the data unit.

8. The method of claim 7, wherein classifying comprises:
determining the type of service according to a content of the data unit.

9. The method of claim 7, wherein classifying comprises:
classifying the data unit according to one or more parameters of a traffic stream.

10. The method of claim 9 comprising:
queuing into two or more queues a classified data unit based on the type of service and a desired parameter of the traffic stream, respectively.

11. The method of claim 10 comprising:
scheduling classified data unit for transmission from a desired queue of the two or more queues.

12. The method of claim 11, further comprising:
controlling transmission of the classified data unit according to a desired quality of service mechanism.

13. A wireless communication device comprising:
a classifier to classify a data unit according to a type of service of the data unit and to output a classified data unit;
a transmitter controller to control transmission of the classified data unit according to a transmission mechanism suitable for a class of the data unit; and
a dipole antenna to transmit the classified data unit.

14. The wireless communication device of claim 13, wherein the classifier is capable of classifying the data unit according to one or more parameters of a traffic stream.

15. The wireless communication device of claim 14, comprising:
two or more queues to store the data unit base on the type of service and a desired parameter of the traffic stream, respectively.

16. The wireless communication device of claim 15, comprising:
a quality of service scheduler to schedule the classified data unit for transmission from a desired queue of the two or more queues.

17. The wireless communication device of claim 16, comprising:
two or more quality of service controllers to control the transmission of the classified data unit according to a desired quality of service mechanism.

18. The wireless communication device of claim 13, wherein the transmission mechanism includes a quality of service mechanism.

19. An article comprising a storage medium, having stored thereon instructions, that when executed, result in:
classifying and queuing a data unit for transmission according to a type of service of the data unit; and
determining the type of service according to a content of the data unit.

20. The article of claim 19, wherein the instruction of classifying, when executed, results in:
classifying the data unit according to one or more parameters of a traffic stream.

21. The article of claim 20, wherein the instructions, when executed, result in:
queuing into two or more queues a classified data unit base on the type of service and a desired parameter of the traffic stream, respectively.

22. The article of claim 20, wherein the instructions, when executed, result in:
scheduling classified data unit for transmission from a desired queue of the two or more queues.

23. The article of claim 22, wherein the instructions, when executed, result in:
controlling the transmission of the classified data unit according to a desired quality of service mechanism.
